(19) United States
(12) Patent Application Publication
(10) Pub. No.: US 2007/0081111 A1
(43) Pub. Date: Apr. 12, 2007

(54) Double-sided backlight module and double-sided liquid crystal display with same

(75) Inventors: Chih-Hung Chang, Miao-Li (TW); Ching-Huang Lin, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/545,935

(22) Filed: Oct. 10, 2006

(30) Foreign Application Priority Data
Oct. 7, 2005 (TW) 94217367

(51) Int. Cl. G02F 1/1335

(52) U.S. Cl. 349/62

(57) ABSTRACT

An exemplary double-sided liquid crystal display (300) includes two liquid crystal panels (310, 311), a single optical body, and a light source (316). The single optical body is provided between the liquid crystal panels including two light guide plates (314, 315), and a reflection layer (317). The reflection layer is integrally formed with the light guide plates, and the light source is arranged at end portions of the light guide plates.

### FIELD OF THE INVENTION

The present invention relates to backlight modules and liquid crystal displays; and more particularly to a double-sided backlight module, and a double-sided liquid crystal display that incorporates a double-sided backlight module.

### BACKGROUND

A typical liquid crystal display (LCD) includes a backlight module, which provides a planar light source used for displaying of images. A conventional double-sided liquid crystal display generally includes two liquid crystal panels arranged back-to-back and a backlight module provided therebetween. The backlight module includes two light guide plates, and point or linear light sources arranged at end portions of the light guide plates respectively. Light emitted from light sources enters the light guide plates, emits from respective major surfaces of the light guide plates as uniformly distributed light, and reaches the corresponding liquid crystal panels respectively.

Referring to FIG. 6, a conventional double-sided liquid crystal display 100 includes two liquid crystal panels 110, 111, two light guide plates 114, 115 having top and bottom incident sides (not labeled) respectively, two light sources 116, 117 arranged adjacent the incident sides of the light guide plates 114, 115 respectively, two reflection sheets 118, 119 between the light guide plates 114, 115, two diffusers 112, 113 disposed adjacent the light guide plates 114, 115 respectively, and two brightness enhancement films 120, 121 disposed between the diffusers 112, 113 and the liquid crystal panels 110, 111 respectively. Each reflection sheet 118, 119 has a reflective surface (not labeled) facing the corresponding light guide plate 114, 115. Each brightness enhancement film 120, 121 has two lens sheets (not labeled).

The light guide plate 114, the reflection sheet 118, and the diffuser 112 are separate parts that are attached together when the double-sided liquid crystal display 100 is assembled. Similarly, the light guide plate 115, the reflection sheet 119, and the diffuser 113 are separate parts that are attached together when the double-sided liquid crystal display 100 is assembled. Therefore, gaps containing air exist between the light guide plates 114, 115 and the reflection sheets 118, 119 respectively, and between the light guide plates 114, 115 and the diffusers 112, 113 respectively. Light emitted from the light sources 116, 117 enters the corresponding light guide plates 114, 115. Part of this light emits from light emitting surfaces (not labeled) of the light guide plates 114, 115 with the aid of reflection by the reflection sheets 118, 119. The light is then scattered by the diffusers 112, 113, gathered by the bright enhancement films 120, 121, and finally enters the liquid crystal panels 110, 111. However, because of the above-described air gaps, a certain amount of back reflection of light occurs at surfaces of the light guide plates 114, 115 and surfaces of the diffusers 112, 113. The back-reflected light needs to be reflected (or re-reflected) by the reflection sheets 118, 119 before it can transmit through to the respective liquid crystal panels 110, 111. Because the back-reflected light must transmit through various additional interfaces before it reaches the respective liquid crystal panels 110, 111, it undergoes additional loss of light energy. If the loss of light energy is significant, the quality of images displayed by the liquid crystal panels 110, 111 may be unsatisfactory, or the double-sided liquid crystal display 100 may need to consume too much electrical power.

What is needed is a double-sided backlight module and a double-sided liquid crystal display that can overcome the above-described disadvantages.

### SUMMARY

An exemplary double-sided backlight module includes a single optical body, and at least one light source. The single optical body includes two light guide plates, and at least a reflection layer. The at least one reflection layer is integrally formed with at least one of the light guide plates, and the at least one light source is arranged at end portion of at least one of the light guide plates.

An exemplary double-sided liquid crystal display includes two liquid crystal panels, a single optical body, and at least one light source. The single optical body is provided between the liquid crystal panels including two light guide plates, and at least one reflection layer. The at least one reflection layer is integrally formed with the at least one of the light guide plates, and the at least one light source is arranged at end portion of at least one of the light guide plates.

Unlike in the prior art, the light guide plates and the reflection layer of the backlight module are integrally formed; thus, no gap is between the light guide plates and the reflection layer. The light incident into the light guide plates is reflected back into the light guide plates respectively again by the reflection layer. The structures above-mentioned can reduce the medium and the interface caused by gaps during the transmission of light and reduce the loss of the light as well.

A detailed description of embodiments of the present invention is given below with reference to the accompanying drawings.

### BRIEF DESCRIPTION OF THE DRAWINGS

In the drawings, all the views are schematic.

FIG. 1 is an exploded side view of a double-sided liquid crystal display in accordance with a first embodiment of the present invention.

FIG. 2 is a side view of a diffuser, a light guide plate, and a reflection layer of a first liquid crystal display module of the double-sided liquid crystal display of FIG. 1.

FIG. 3 is an exploded side view of a double-sided liquid crystal display in accordance with a second embodiment of the present invention.

FIG. 4 is an exploded side view of a double-sided liquid crystal display in accordance with a third embodiment of the present invention.

FIG. 5 is an exploded side view of a double-sided liquid crystal display in accordance with a fourth embodiment of the present invention.

FIG. 6 is an exploded isometric view of a conventional double-sided liquid crystal display.

### DETAILED DESCRIPTION OF PREFERRED EMBODIMENTS

Referring to FIG. 1, this is a schematic, exploded side view of a double-sided liquid crystal display in accordance with a first embodiment of the present invention. The double-sided liquid crystal display 200 includes first and second liquid crystal display modules 230, 240 each having a display side (not labeled) and a back side (not labeled). The first and second liquid crystal display modules 230, 240 are arranged back-to-back.

The first liquid crystal display module 230 includes a first liquid crystal panel 210, and a first backlight module 222. The first backlight module 222 includes a substantially flat light guide plate 214, which has a light emitting side (not labeled) and an incident side (not labeled). The first backlight module 222 also includes a light source 216 provided at the incident side of the light- guide plate 214, a reflection layer 218 on a back side of the light guide plate 214 (opposite to the light emitting side), a diffuser 212 on the light emitting side of the light guide plate 214, and a brightness enhancement film 220 adjacent the diffuser 212. The light guide plate 214, the diffuser 212 and the reflection layer 218 are integrally formed as a single body. The brightness enhancement film 220 includes two lens sheets (not labeled).

The second liquid crystal display module 240 includes a second liquid crystal panel 211, and a second backlight module 233. The second backlight module 233 includes a substantially flat light guide plate 215, which has a light emitting side (not labeled) and an incident side (not labeled). The second backlight module 233 also includes a light source 217 provided at the incident side of the light guide plate 215, a reflection layer 219 on a back side of the light guide plate 215 (opposite to the light emitting side), a diffuser 213 on the light emitting side of the light guide plate 215, and a brightness enhancement film 221 adjacent the diffuser 213. The light guide plate 215, the diffuser 213 and the reflection layer 219 are integrally formed as a single body. The brightness enhancement film 221 includes two lens sheets (not labeled).

The first and second liquid crystal display modules 230, 240 are arranged substantially parallel to each other, with the first and second backlight modules 222, 233 being positioned back-to-back. In particular, the reflection layers 218, 219 are positioned back-to-back.

In alternative embodiments, the incident side of either or both of the light guide plates 214, 215 can be provided at a different location on the respective light guide plate 214, 215. In such cases, the light sources 216, 217 are provided at the respective incident sides of the light guide plates 214, 215. In another alternative embodiment, the light sources 216, 217 can be replaced by a single common light source, which is provided adjacent the incident sides of both the light guide plates 214, 215.

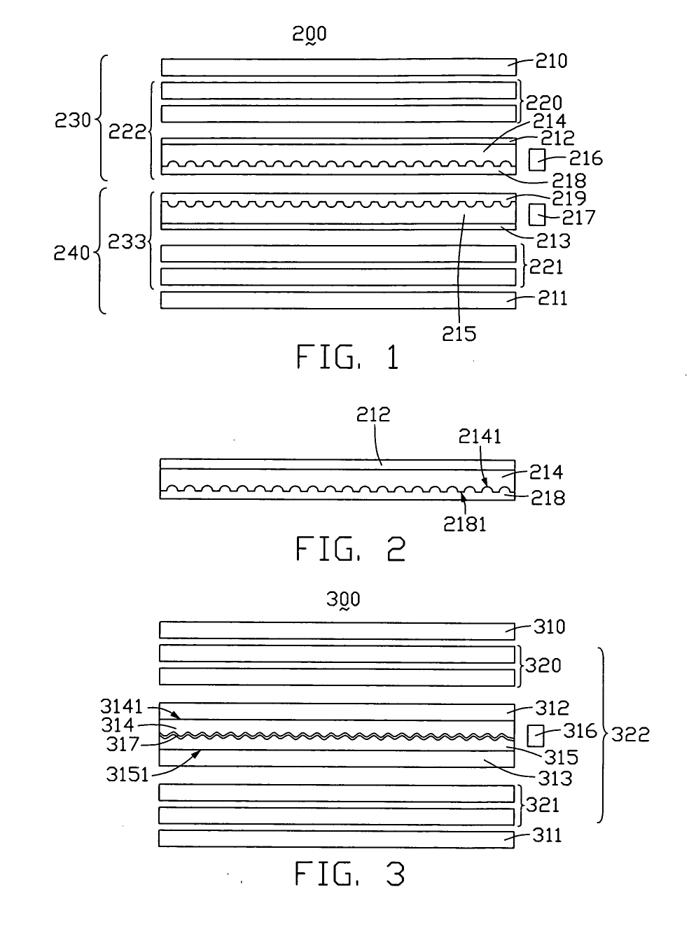

FIG. 2 is a side view of the diffuser 212, the light guide plate 214, and the reflection sheet 218. The light guide plate 214 further has a bottom surface 2141, and the reflection layer 218 has a top surface 2181 in immediate contact with the bottom surface 2141. The diffuser 212 is in immediate contact with the light emitting side of the light guide plate 214. A plurality of substantially convex structures for light scattering is formed at the top surface 2181, and a plurality of complementary concave structures for light scattering is formed at the bottom surface 2141. The convex and concave structures are in immediate contact with each other. The diffuser 212 and the reflection layer 218 can be formed on the respective side or surface of the light guide plate 214 by any of various deposition, coating, molding, or layering processes known in the art.

Light emitted from the light source 216 enters the light guide plate 214 via the incident side thereof. Part of the light emits from the light emitting side without ever reaching the bottom surface 2141. Another part of the light exits the bottom surface 2141, is reflected by the reflection layer 218, reenters the light guide plate 214 via the bottom surface 2141, and then emits from the light emitting side. All the light emitted from the light emitting side of the light guide plate 214 is scattered by the diffuser 212, gathered by the bright enhancement film 220, and then enters the corresponding first liquid crystal panel 210.

Light emitted from the light source 217 enters the light guide plate 215 via the incident side thereof. Part of the light emits from the light emitting side without ever reaching a top surface (not labeled) of the light guide plate 215. Another part of the light exits the top surface, is reflected by the reflection layer 219, reenters the light guide plate 215 via the top surface, and then emits from the light emitting side. All the light emitted from the light emitting side of the light guide plate 215 is scattered by the diffuser 213, gathered by the bright enhancement film 221, and then enters the corresponding second liquid crystal panel 211.

Because of the integral structure of the light guide plate 214, the diffuser 212 and the reflection layer 218, there are essentially no air gaps therebetween. Similarly, because of the integral structure of the light guide plate 215, the diffuser 213, and the reflection layer 219, there are essentially no air gaps therebetween. Therefore, the occurrence of back reflection at the respective interfaces is reduced or even eliminated. Thus corresponding loss of light energy is reduced or even eliminated, thereby providing the first and second liquid crystal panels 210, 211 with optimal capability to display good quality images with minimal power consumption.

Referring to FIG. 3, this is a schematic, exploded side view of a double-sided liquid crystal display in accordance with a second embodiment of the present invention. The double-sided liquid crystal display 300 includes first and second liquid crystal panels 310, 311 each having a display side (not labeled) and a back side (not labeled). The first and second liquid crystal displays panels 310, 311 are arranged substantially parallel to each other and back-to-back relative to each other, with a backlight module 322 being provided therebetween.

The backlight module 322 includes two substantially flat light guide plates 314, 315. The light guide plate 314 has a light emitting side 3141 and an incident side (not labeled). A diffuser 312 is formed on the light emitting side of the light guide plate 314, and a brightness enhancement film 320 is positioned adjacent a front side of the diffuser 312. The light guide plate 315 has a light emitting side 3151 and an incident side (not labeled). A diffuser 313 is formed on the light emitting side 3141 of the light guide plate 315, and a brightness enhancement film 321 is positioned adjacent a front side of the diffuser 313. Each of the brightness enhancement films 320, 321 includes two lens layers (not labeled).

A substantially rippled reflection layer 317 is formed between the light guide plates 314, 315. The reflection layer 317 has two opposite reflective sides (not labeled) in immediate contact with respective back sides of the light guide plates 314, 315, and a plurality of light transmission areas. A single light source 316 is provided adjacent the incident sides of the light guide plates 314, 315. The light guide plates 314, 315, the diffusers 312, 313 and the reflection layer 317 are integrally formed as a single body.

In alternative embodiments, there can be two light sources 316 instead of only the single light source 316. In such case, the incident side of either or both of the light guide plates 314, 315 can be provided at a different location on the respective light guide plate 314, 315, with the light sources 316 being provided at the respective incident sides of the light guide plates 314, 315. In another alternative embodiment, the reflection layer 317 can only have a single reflective side.

Light emitted from the light source 316 enters the light guide plates 314, 315 via the incident sides thereof and reaches the reflection layer 317. Part of the light is reflected by the corresponding reflective sides of the reflection layer 317, and emits from the emitting sides 3141, 3151. Another part of the light transmits through the light transmission areas of the reflection layer 317, emits from the emitting surfaces 3141, 3151. All the light emitted from the emitting surfaces 3141, 3151 of the light guide plates 314, 315 is respectively scattered by the diffusers 312, 313, gathered by the bright enhancement films 320, 321, and then enters the corresponding first and second liquid crystal display panels 310, 311 respectively.

The light guide plates 314, 315, the diffusers 312, 313, and the reflection layer 317 are integrally formed as a single body, with no air gaps therebetween. Therefore, the occurrence of back reflection at the respective interfaces is reduced or even eliminated. Thus corresponding loss of light energy is reduced or even eliminated, thereby providing the first and second liquid crystal panels 310, 311 with optimal capability to display good quality images with minimal power consumption.

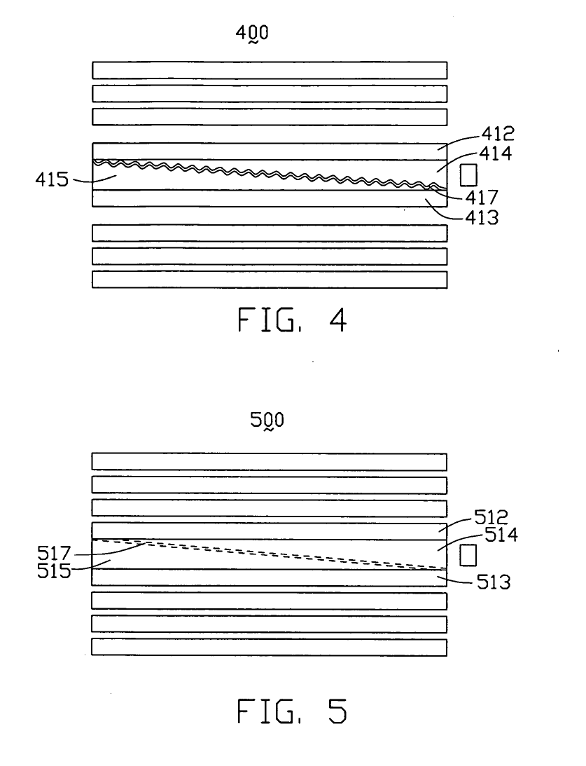

Referring to FIG. 4, this is a schematic, exploded side view of a double-sided liquid crystal display in accordance with a third embodiment of the present invention. The double-sided liquid crystal display 400 of the third embodiment is similar to the above-described second embodiment. However, the double-sided liquid crystal display 400 includes light guide plates 414, 415, diffusers 412, 413, and a reflection layer 417, which are all integrally formed together as a single body. The light guide plates 414, 415 are generally wedge-shaped. The reflection layer 417 is oriented at an oblique angle between the light guide plates 414, 415. The light guide plates 414, 415 are oriented complementary to one another, such that an overall thickness of said single body is substantially uniform.

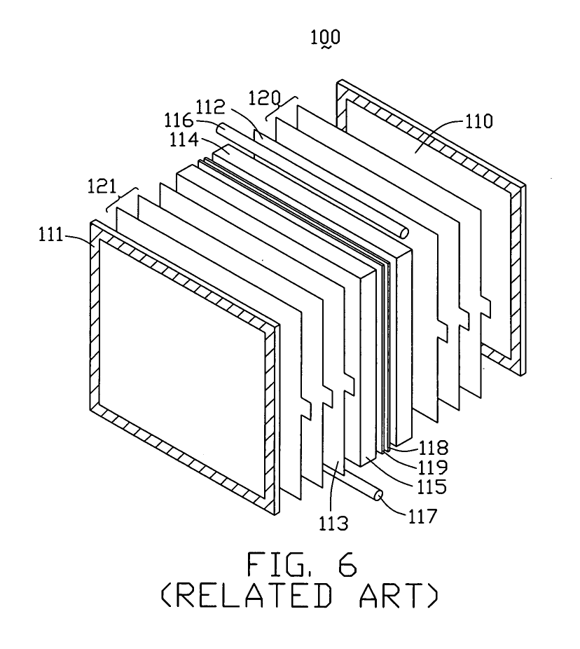

Referring to FIG. 5, this is a schematic, exploded side view of a double-sided liquid crystal display in accordance with a fourth embodiment of the present invention. The double-sided liquid crystal display 500 of the fourth embodiment is similar to the above-described third embodiment. However, the double-sided liquid crystal display 500 includes light guide plates 514, 515, diffusers 512, 513, and a reflection layer 517, which are all integrally formed together as a single body. The reflection layer 517 has two opposite reflective sides (not labeled) in immediate contact with respective back sides of the light guide plates 514, 515, and a plurality of light transmission holes (not labeled). Thereby, the reflection layer 517 provides both reflection and transmission of light. The light transmission holes may be filled with air.

In various alternative embodiments, a plurality of convex structures can be formed on the reflection layers 317, 417, 517, thereby increasing the light scattering capability thereof. The light transmission areas of the reflection layers 317, 417 can have any kind of suitable configuration, such as being circular or square in cross-section. The light transmission holes of the reflection layers 517 can have any kind of suitable configuration, such as being circular or square in cross-section. A plurality of light transmission holes can be formed in the reflection layers 317, 417.

While preferred and various embodiments have been described above by way of example, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements

What is claimed is:

1. A double-sided backlight module, comprising:
a single optical body comprising two light guide plates and at least one reflection layer integrally formed with at least one of the light guide plates; and
at least one light source arranged at an end portion of at least one of the light guide plates.

2. The double-sided backlight module as claimed in claim 1, wherein the single optical body further comprises two diffusers, and each of the diffusers is integrally formed with a respective one of the light guide plates at a side thereof distal from the at least one reflection layer.

3. The double-sided backlight module as claimed in claim 1, further comprising two brightness enhancement films provided adjacent the diffusers respectively.

4. The double-sided backlight module as claimed in claim 1, wherein the at least one reflection layer is two reflection layers, and each of the reflection layers is integrally formed with a respective one of the light guide plates.

5. The double-sided backlight module as claimed in claim 4, wherein the at least one reflection layer comprises a plurality of convex structures, and at least one of the light guide plates comprises a plurality of concave structures in immediate contact with the corresponding convex structures.

6. The double-sided backlight module as claimed in claim 1, wherein the at least one reflection layer is a single reflection layer, which has two rippled reflective sides.

7. The double-sided backlight module as claimed in claim 6, wherein the single reflection layer is integrally formed with both the light guide plates.

8. The double-sided backlight module as claimed in claim 1, wherein the at least one reflection layer is a single reflection layer, which has a plurality of light transmission areas.

9. The double-sided backlight module as claimed in claim 1, wherein the at least one reflection layer is a single reflection layer, and the light guide plates are generally wedge-shaped.

10. The double-sided backlight module as claimed in claim 1, wherein the at least one reflection layer is a single reflection layer, which has a plurality of light transmission holes.

11. A double-sided liquid crystal display, comprising:
two liquid crystal panels opposite to each other;
a single optical body between the liquid crystal panels, the single optical body comprising two light guide plates, and at least one reflection layer integrally formed with at least one of the light guide plates; and
at least one light source arranged at an end portion of at least one of light guide plates.

12. The double-sided liquid crystal display as claimed in claim 11, wherein the single optical body further comprises two diffuses, and each of the diffusers is integrally formed with a respective one of the light guide plates at a side thereof distal from the at least one reflection layer.

13. The double-sided liquid crystal display as claimed in claim 11, further comprising two brightness enhancement films provided adjacent the diffusers respectively.

14. The double-sided liquid crystal display as claimed in claim 11, wherein the at least one reflection layer is two reflection layers, and each of the reflection layers is integrally formed with a respective one of the light guide plates.

15. The double-sided liquid crystal display as claimed in claim 14, wherein the at least one reflection layer comprises a plurality of convex structures, and at least one of the light guide plates comprises a plurality of concave structures in immediate contact with the corresponding convex structures.

16. The double-sided liquid crystal display in claimed in claim 11, wherein the at least one reflection layer is a single reflection layer, which has two rippled reflective sides.

17. The double-sided liquid crystal display in claimed in claim 16, wherein the single reflection layer is integrally formed with both the light guide plates.

18. The double-sided liquid crystal display as claimed in claim 11, wherein the at least one reflection layer is a single reflection layer, which has a plurality of light transmission areas.

19. The double-sided liquid crystal display as claimed in claim 1 1, wherein the at least one reflection layer is a single reflection layer, and the light guide plates are generally wedge-shaped.

20. A double-sided liquid crystal display comprising:
two liquid crystal panels opposite to each other;
a single optical body between the liquid crystal panels, the single optical body comprising two light guide plates cooperating with each other to integrally sandwich at least one reflection layer therebetween; and
at least one light source arranged at an end portion of said single.
